(19) United States
(12) Patent Application Publication
(10) Pub. No.: US 2011/0214943 A1
(43) Pub. Date: Sep. 8, 2011

(54) LADDER ASSEMBLY

(76) Inventor: Charles Patrick McElroy, Wickliffe, OH (US)

(21) Appl. No.: 13/041,298

(22) Filed: Mar. 4, 2011

Related U.S. Application Data
(60) Provisional application No. 61/310,707, filed on Mar. 5, 2010.

(51) Int. Cl. E06C 7/18

(52) U.S. Cl. 182/107

(57) ABSTRACT

A ladder assembly (10) comprising a pair of plinths (30) pivotally connected to the bottom ends (22) of the ladder posts (21). To use the ladder assembly (10), the plinths (30) are positioned on a substantially horizontal support surface (H) and the top ends (23) of the ladder posts (21) are propped against a vertical surface (V). Easily installable and/or easily removable anchors (40) are then used to anchor the plinths (30) to the horizontal surface (H).

### RELATED APPLICATION

This application claims priority under 35 U.S.C. §119(e) to U.S. Provisional Patent Application No. 61/310,707 filed on Mar. 5, 2010. The entire disclosure of this earlier application is hereby incorporated by reference.

### BACKGROUND

A ladder can be used to reach an elevated area on the outside of a building. One simple and common type of ladder comprises a pair of parallel posts and a plurality of rungs extending perpendicularly therebetween. When using this ladder, the bottom ends of the posts rest on a horizontal support surface (e.g., the ground), and their top ends prop against a vertical surface (e.g., the outside wall of a building). The ladder rungs form steps from the posts' bottom ends to their top ends.

### SUMMARY

A ladder assembly provides a safe and simple way to insure that the ladder structure remains secure when it is placed on an outside surface. In this assembly, plinths are permanently, and preferably pivotally, connected to the bottom end of each ladder post. Easily installable anchors extend below each plinth for anchoring the ladder structure to a substantially flat horizontal surface (e.g., the ground). When a job is completed, the anchors are removed, and the ladder assembly moved to a new location.

### DRAWINGS

FIGS. 1 and 2 are each a schematic drawing of a ladder assembly being used to reach an elevated area on the outside of a building, the ladder assembly being shown from the side in FIG. 1 and from the front in FIG. 2.

FIG. 1A and FIG. 2A are enlarged views of the corresponding portions in FIG. 1 and FIG. 2, respectively.

FIG. 3 is a top view of a plinth of the ladder assembly shown in FIGS. 1-2.

FIG. 4 is side view of an anchor of the ladder assembly.

FIG. 5 is similar to FIG. 2, except that the plinths are merged into one piece.

### DESCRIPTION

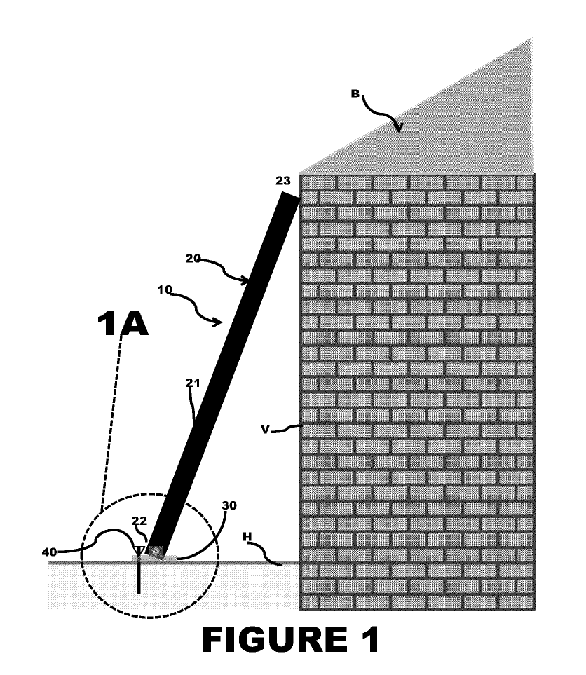

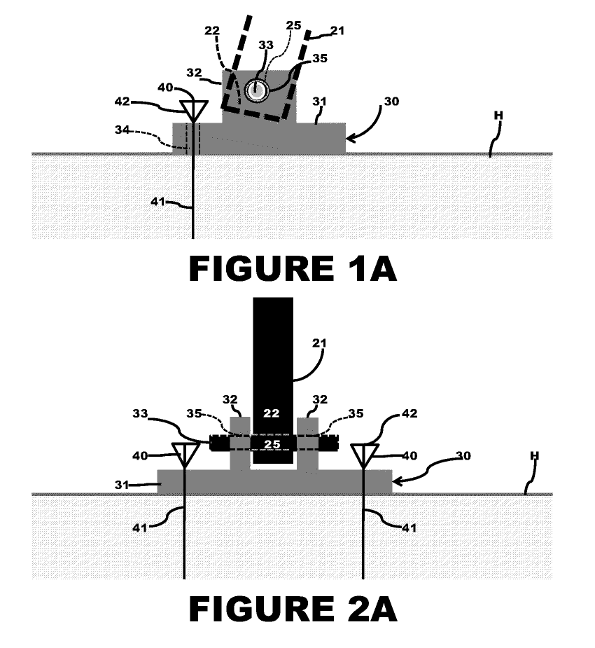

Referring now to the drawings, and initially to FIGS. 1 and 2, a ladder assembly 10 is shown being used to reach an elevated area of a building B. In the illustrated embodiment, the horizontal support surface H is the ground and the relevant vertical surface V is the outside wall of the building B.

The ladder assembly 10 comprises what may be a conventional ladder structure 20 having parallel posts 21 (with a bottom end 22 and a top end 23) and rungs 24 extending perpendicularly therebetween. The posts 21 will usually have the same dimensions and, in any event, will be of a length sufficient to reach the elevated height (e.g., at least ten feet, at least fifteen feet, at least twenty feet, etc.). And although not specifically shown in the drawings, the posts 21 may incorporate telescoping and/or other extension means for selective elongation of the ladder structure 21. In the illustrated embodiment, the bottom end 22 of each post 21 includes a bushing 25 which coordinates with another component of the ladder assembly 10 (namely a pivot pin 33, introduced below).

The rungs 24 form steps from the posts' bottom ends 23 to their top ends 24, whereby they may be easily climbed to necessary elevated height. To this end, the ladder assembly 10 can have a suitable number of rungs 24 (e.g., at least six, at least eight, at least ten, at least twelve, etc.). The rungs 24 can be equally spaced apart an appropriate distance (e.g., at least ten inches, at least twelve inches, less than twenty inches, etc.).

As is best seen by referring additionally to FIG. 1A and 2A, the ladder assembly 10 further comprises a pair of plinths 30 and anchors 40. One plinth 30 is connected to the bottom end 22 of one post 21 and the other plinth 30 is connected to the bottom end 22 of the other post 21. The post-to-plinth connection can be a pivotal connection (as shown), thereby allowing adjustment of the incline angle of the posts 21.

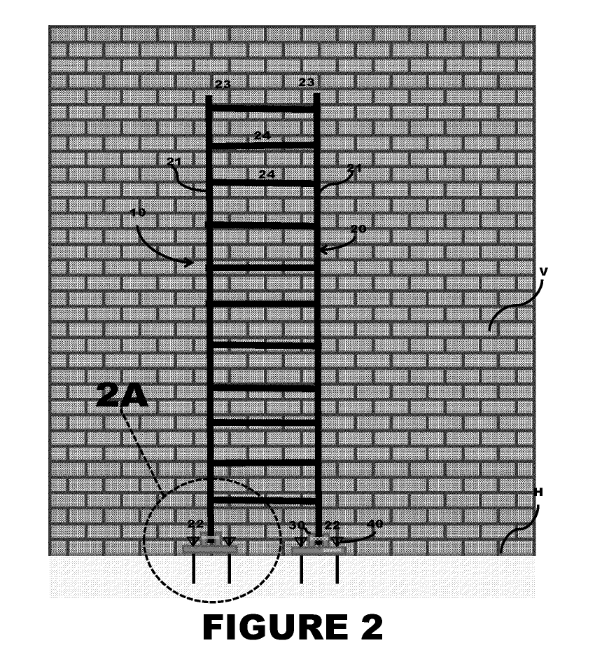

As is best seen by referring additionally to FIG. 3, the plinths 30 can each include a base platform 31, brackets 32, and a pivot pin 33. The platform 31 has a bottom side adapted to rest relatively flush against the horizontal support surface H and a top side to which the brackets 32 are fixed. A plurality of openings 34 extend through the platform 31 and they can be arranged along its front and lateral edges and around the brackets 32.

The brackets 32 are spaced apart to form a cradle receptacle for the bottom end 23 of the respective post 21. They each have a channel 35 extending therethrough and these channels align with the bushing 23 when the post 21 is received therein. The pivot pin 33 extends through the bushing 25 and the channels 35 to form an axis for post incline adjustment.

The anchors 40 extend below the plinth 30 to securely anchor it, and thus the ladder structure 20, to the horizontal support surface H. In the illustrated ladder assembly 10, the anchors 40 extend through the platform 31 (i.e., through the openings 34). However, other anchoring arrangements are possible and contemplated.

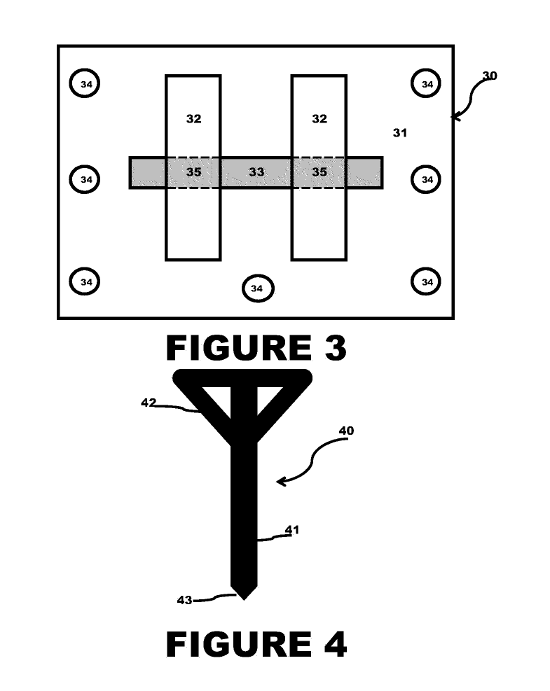

As is best seen by referring additionally to FIG. 4, the anchors 40 each comprise a shank 41 and a head 42. The shank 41 has a cross-sectional dimension compatible within insertion through the platform openings 34 and a length dimension sufficient to extend far enough below the platform 31 (e.g., at least two inches below, at least three inches below, at least four inches below, at least five inches below, and/or at least six inches below). And it can have a tapered distal end 43 to encourage burrowing into the ground.

The head 42 have a wider cross-section than the platform openings 34 to signal when a sufficient depth has been reached by the shank 41 and/or to prevent the anchor 30 from being driven too deep. The head 42 preferably has a geometry facilitating its insertion during setup of the ladder assembly 10 and its removal during teardown. For example, the head 42 can have a crown adapted to be pressed by a hand, pushed by a foot, pounded with a hammer, and/or hit with a rock. Additionally or alternatively, the head 42 can have open crevices allowing it be hooked by a lever for easy removal.

The ladder assembly 10 preferably comprises one or more anchors 40 for each plinth 30 (e.g., at least one anchor 40, at least two anchors 40, at least three anchors 40, at least four anchors 40, at least five anchors 40, at least five anchors 40, at least six anchors 40, and/or at least seven anchors 40.)

To use the ladder assembly 10, the plinths 30 are positioned on the substantially horizontal support surface H, the top ends 23 of the posts 21 are propped against the vertical surface V, and the plinths 30 are anchored to the horizontal support surface H with the anchors 40. Once the job at the elevated area is completed, the anchors 40 can be removed and the ladder assembly 10 moved to a new location. The new location, the positioning, propping, and anchoring steps can be repeated.

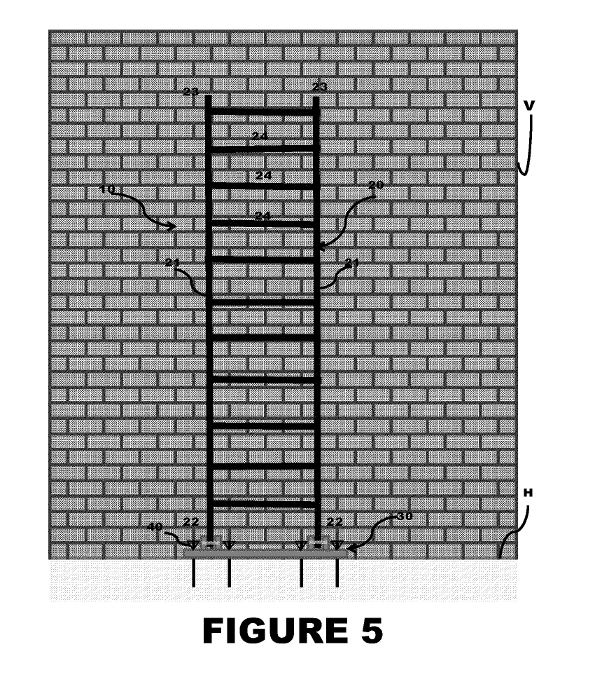

In FIGS. 1-3, the plinths 30 were formed as separate pieces. However, as shown in FIG. 5, they could instead be joined together in a single piece.

One may now appreciate that the ladder assembly 10 provides a safe and simple way to insure that the ladder structure 20 will remain secure when it is placed on an outside surface. Although the assembly 10, the ladder structure 20, the plinth 30, and/or the anchors 40 have been shown and described with respect to a certain embodiment or embodiments, it is obvious that equivalent alterations and modifications will occur to others skilled in the art upon the reading and understanding of this specification and the annexed drawings.

1. A ladder assembly comprising:
a ladder structure including a pair of parallel posts each having a bottom end and a top end, and a plurality of rungs extending perpendicular between the parallel posts;
a pair of plinths, with one plinth being connected to the bottom end of one post and the other plinth being connected to the bottom end of the other post; and
anchors extending below each plinth for anchoring to a substantially flat horizontal surface.

2. A ladder assembly as set forth in claim 1, wherein the plinths are pivotally connected to the posts.

3. A ladder assembly as set forth in claim 1, wherein the plinths each comprise a platform, wherein the anchors extend below these platforms, and wherein the platform has bottom side adapted to lie substantially flush against the horizontal surface.

4. A ladder assembly as set forth claim 1, wherein the plinths each include a pair of brackets forming a cradle receptacle for the bottom end of the respective post.

5. A ladder assembly as set forth in claim 1, wherein the plinths each include a pivot pin extending through a bushing in the bottom end of the respective post.

6. A ladder assembly as set forth in claim 5, comprising at least two anchors for each plinth.

7. A ladder assembly as set forth in claim 6, comprising at least four anchors for each plinth.

8. A ladder assembly as set forth in claim 7, comprising at least six anchors for each plinth.

9. A ladder assembly as set forth in claim 6, wherein the plinth includes an opening for each anchor,
wherein a platform of the plinth includes the openings for each anchor;
wherein each anchor comprises a shank and a head; and
wherein the shank has a cross-sectional dimension small enough to fit through plinth openings.

10. A ladder assembly as set forth in claim 9, wherein each shank has a tapered distal end.

11. A ladder assembly as set forth in claim 9, wherein the shank is sized to extend below the plinth for at least two inches.

12. A ladder assembly as set forth in claim 9, wherein the shank is sized to extend below the plinth for at least four inches.

13. A ladder assembly as set forth in claim 9, wherein each shank has a tapered distal end and is sized to extend below the plinth for at least two inches.

14. A ladder assembly as set forth in claim 9, wherein the head of each anchor is larger than the corresponding opening in the plinth.

15. A ladder assembly as set forth in claim 9, wherein the head of the anchor has a geometry adapted to be pressed by a hand, pushed by foot, pounded by a hammer, and/or hit with a rock.

16. A ladder assembly as set forth in claim 9, wherein the head has crevices for engagement of hook during removal.

17. A ladder assembly as set forth in claim 9, wherein:
the shank has a tapered distal end and is sized to extend below the plinth for at least two inches;
the head of each anchor is larger than the corresponding opening in the plinth;
the head of the anchor has a geometry adapted to be pressed by a hand, pushed by foot, pounded by a hammer, and/or hit with a rock; and
the head has crevices for engagement of hook during removal.

18. A ladder assembly as set forth in claim 1, wherein each anchor has a head adapted to be pressed by a hand, pushed by foot, pounded by a hammer, and/or hit with a rock.

19. A method of using the ladder assembly set forth claim 1, said method comprising the steps of:
positioning the plinths on a substantially horizontal support surface;
propping the top ends of the posts against a vertical surface;
anchoring the plinths to the substantially horizontal support surface with the anchors.

20. A method as set forth in claim 19, further comprising the steps of removing the anchors, moving the ladder assembly to a new location, and repeating the positioning, propping, and anchoring steps at the new location.
